(19) United States
(12) Patent Application Publication
(10) Pub. No.: US 2005/0235143 A1
(43) Pub. Date: Oct. 20, 2005

(54) Mobile network authentication for protection stored content

(75) Inventor: Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkljke Philips Electronics N.V., Eindhoven (NL)

(21) Appl. No.: 10/524,573

(22) PCT Filed: Aug. 4, 2003
(86) PCT No.: PCT/IB03/03434

§ 371 Date: Feb. 15, 2005

(30) Foreign Application Priority Data
Aug. 20, 2002 (EP) 02078437.7

(51) Int. Cl. H04L 9/00

(52) U.S. Cl. 713/165; 713/189

(57) ABSTRACT

The present invention relates to a method of protecting content stored on a storage medium (7) against unauthorized access, said storage medium (7) being accessible by a drive (D) of a portable device (2) which is connectable to a network (1). In order to provide a high level of protection against unauthorized access it is proposed to use the authentication procedure of the network (1) to generate a cryptographic key (ck) for encryption and decryption of content stored on said storage medium (7). In particular, the present invention is used in a mobile phone network where the authentication key (ak) is stored on a SIM card (8) used in a mobile phone (2).

The present invention relates to a method of and a device for protecting content stored on a storage medium against unauthorized access, said storage medium being accessible by a drive of a portable device which is connectable to a network. Further, the present invention relates to a method of and a device for accessing such content and to a computer program for implementing said methods. The invention relates in particular to a mobile phone comprising a drive for accessing a removable storage medium.

Next generations of portable devices, such as in particular mobile phones, will include a drive for accessing a removable storage medium, such as a small form factor optical (SFFO) disc, a removable hard disc or a semiconductor memory. These removable storage media will be used to store users' private data such as photos, videos, medical records or other information. One of the requirements is that this user content is protected against unauthorized access so that in case the storage medium is lost or stolen, the stored content is not readable by anyone. To provide such privacy protection, only the user who recorded the content shall preferably be able to access the content. The protection should further be adapted such that the user does not easily lose access to the content, e.g. by forgetting a key or password. Further, the user should be able to choose if content shall be protected or not.

It is therefore an object of the present invention to provide a method of and device for protecting content which fulfil the above described requirements and guarantee protection against unauthorized access of content stored on a storage medium. Further, a method of and device for accessing such content shall be provided.

This object is achieved according to the present invention by a method of protecting content stored on a storage medium against unauthorised access, said storage medium being accessible by a drive of a portable device which is connectable to a network, said method comprising the steps of:
transmitting an identifier of said storage medium or the user to an authentication unit within said portable device or within said network,
generating a cryptographic key using said identifier and an authentication key by an authentication algorithm within said authentication unit,
transmitting said cryptographic key from said authentication unit to said drive,
encrypting the content to be protected using said cryptographic key, and
storing the encrypted content on said storage medium.

This object is further achieved according to the present invention by a device for protecting content stored on a storage medium against unauthorized access, said storage medium storing a machine-readable identifier, said device comprising:
means for connecting said device to a network,
a drive for accessing said storage medium, in particular for reading content from and writing content to said storage medium,
a transmitter for transmitting an identifier of said storage medium or the user to an authentication unit within said device or within said network, a receiver for receiving a cryptographic key generated within said authentication unit by an authentication algorithm using said identifier and an authentication key and for transmitting said cryptographic key to said drive, and
encryption means for encrypting content to be protected using said cryptographic key for storage on said storage medium.

The invention is based on the idea to use an authentication method used for authenticating said portable device within the network, in particular when that portable device connects to the network, for generating a cryptographic key which can then be used for encrypting content if required. Such authentication procedures, as for instance the authentication procedure for a mobile phone network, are very secure. Breaking the authentication algorithm used in a mobile phone network would allow the user to make calls that would be billed to other users. Therefore, the level of protection of such an authentication algorithm is very high and is considered to be sufficient for protecting the user's data when using the authentication algorithm for generating an encryption key as proposed according to the present invention.

Preferred embodiments of the invention are defined in the dependent claims. A method of accessing content protected according to the method of protecting content according to the present invention comprises the steps of:
transmitting an identifier of said storage medium or the user to an authentication unit within said portable device or within said network,
generating a cryptographic key using said identifier and an authentication key by an authentication algorithm within said authentication unit,
transmitting said cryptographic key from said authentication unit to said drive, and
decrypting the content to be accessed using said cryptographic key.

A device for accessing content protected according to the method of protecting content according to the present invention comprises:
means for connecting said device to a network,
a drive for accessing said storage medium, in particular for reading content from and writing content to said storage medium,
a transmitter for transmitting an identifier of said storage medium or the user to an authentication unit within said device or within said network, a receiver for receiving a cryptographic key generated within said authentication unit by an authentication algorithm using said identifier and an authentication key and for transmitting said cryptographic key to said drive, and
decryption means for decrypting content to be accessed using said cryptographic key.

The invention further relates to a computer program for implementing the methods according to the present invention.

According to preferred embodiment of the invention the authentication unit is part of the portable device, i.e. is a SIM (Subscriber Identity Module) card reader in a mobile phone. Thus, for generating the cryptographic key, the identifier is transmitted internally within the portable device to the authentication unit, i.e. the SIM card reader, where by use of the authentication procedure the cryptographic key is generated. Therefore a predefined authentication algorithm and an authentication key, which is preferably a shared secret key which is only known to the authentication unit and the network, in particular an authentication instance within the network, are used which are providing a high security against hacking.

In an alternative embodiment, the authentication unit is part of the network. In this embodiment the identifier has to be transmitted to said authentication unit in the network which, after generating a cryptographic key, resends it to the portable device. This is particularly useful if not only the portable device is able to read the storage medium, but other devices as well, such as a PC, which are not directly connectable to the particular network. Thus, the PC could be allowed to send the identifier to the network by an additional equipment, e.g. by using the portable device or via the internet as proposed according to another embodiment. In the network, the cryptographic key will then be generated and transmitted back to the PC which is then able to encrypt and/or decrypt data of the storage medium.

The authentication key, which is preferably a secret key known to the network and the portable device, is either stored in the authentication unit directly or on a removable authentication memory, such as a SIM card, as is the case for a mobile phone network.

According to further embodiments of the invention, the storage medium is either a removable record carrier, such as an optical disc, a removable hard disc or a semiconductor memory card, or a non-removable storage medium, such as a semiconductor memory or a non-removable hard disc. In the latter case, it is preferred that the authentication key is stored on a removable authentication memory readable by an authentication unit within the portable device, but not in the authentication unit directly.

The invention will now be explained in more detail with reference to the drawings in which

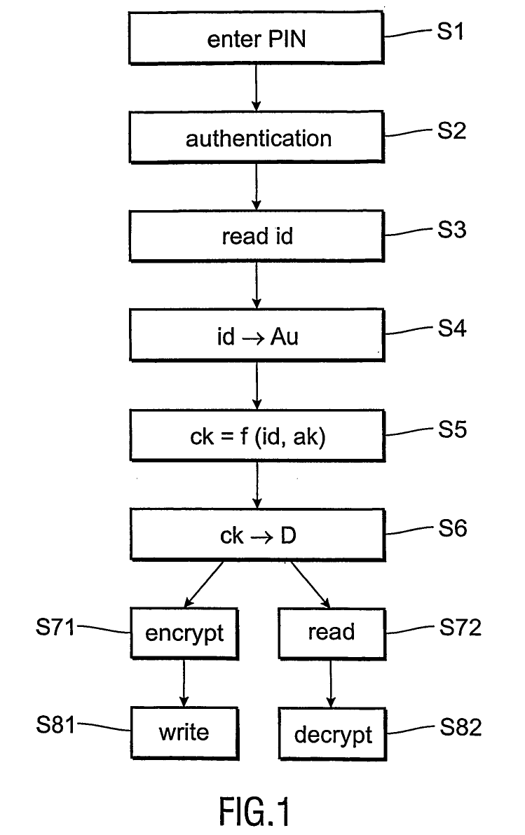

FIG. 1 shows a flow chart illustrating the method of protecting content according to the present invention and

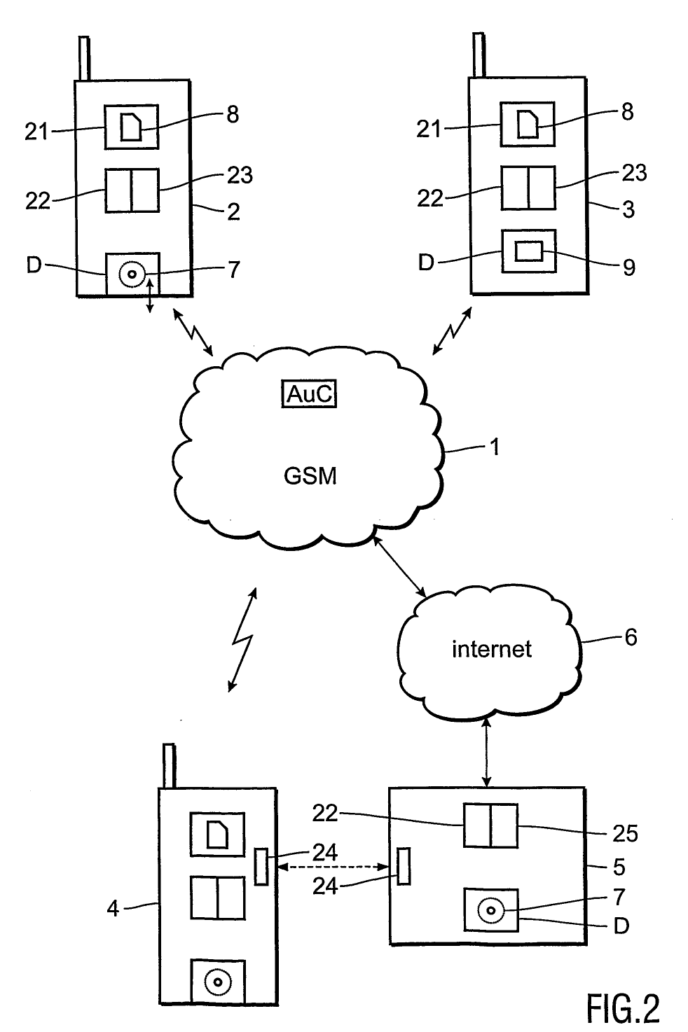

FIG. 2 shows a mobile phone network and a number of different portable device connectable to said network.

In a GSM mobile phone network, each user must be identified by the network before the user can make calls. If this authentication procedure is not secure then it would be possible to impersonate another user and make calls that would be billed to their account. The network does not authenticate against the actual mobile phone but against the Subscriber Identity Module (SIM) card in the mobile phone. The SIM card is a smart card that can be put into any mobile phone, thus allowing the user to keep the same subscription and number while changing mobile phones.

The authentication works by having a shared secret, in this application generally called authentication key, between the network, in particular an authentication centre (AuC), and the SIM. This authentication key is different for each user. The authentication works by a challenge and response protocol. The network challenges the SIM by sending a number to it. The SIM uses the authentication key of this particular subscriber and a defined authentication algorithm to generate the response which is sent back to the network. The authentication centre of the network performs the same calculation using the subscriber's key and validates the result. If the user's response matches the result of the authentication centre's calculation then the user has been authenticated and can begin using the network, i.e. making phone calls.

UMTS, the next generation mobile network, has a similar procedure as GSM, called Authentication and Key Agreement (AKA) procedure between the authentication centre and the SIM, which is called USIM in UMTS.

FIGS. 1 and 2 illustrate the invention by way of an example of a mobile communication system, such as the GSM system where mobile phones comprise a drive for accessing a removable or non-removable storage medium. FIG. 1 illustrate the steps of the method according to the present invention for accessing such a storage medium in a mobile phone. In a first step S1, before being able to use the mobile phone, the user has to enter its PIN into the mobile phone. Thereafter the mobile phone authenticates the user to the network in step S2 by use of an authentication procedure as described above. After successful authentication the mobile phone can be used.

Before accessing a storage medium by a drive in the mobile phone, a unique identifier stored on the storage medium, e.g. a serial number, is read by the drive in step S3. The identifier id might be really unique or it could be statistically unique, e.g. randomly chosen from a large range of possibility so that in practise it is effectively unique. However, it is not even necessary for particular applications that the identifier id is unique. Moreover, the identifier need not be stored on the storage medium, but could be an identifier of the user as well, e.g. the user's PIN.

This identifier is used as the challenge to the authentication procedure, i.e. in step S4 the identifier is transmitted to the authentication unit AU which is either located within the portable device (the mobile phone) or within the network (the mobile phone network). Therein a response is generated in step S5 using the transmitted identifier id and the authentication key ak used in step S2 for authentication of the user. Taking these parameters as an input to the authentication algorithm, which has already been used in step S2 for authentication, a cryptographic key ck is generated by the authentication unit AU.

The cryptographic key ck is thereafter transmitted back to the drive D of the portable device (S6) where it is either used for encrypting content (S71) and storing the encrypted content on the storage medium (S81) or for reading encrypted content from the storage medium (S72) and for decrypting the read content (S82) before reproduction.

The proposed solution ensures that encrypted content stored on the storage medium can only be decrypted if, in case of a mobile phone where the authentication key is stored on a removable SIM card, the user's SIM card is present. Without the user's SIM card encrypted content stored on the storage medium is unreadable, thus effectively protecting the user's data. In any case, for reading encrypted content, it is necessary that the authentication key is available to the user and that the authentication procedure can be performed.

In case the actual encryption algorithm used to encrypt the data on the storage medium is very weak, thus allowing a hacker to determine the cryptographic key used and hence have a challenge/response pair for this user it is nevertheless not possible for the hacker to determine the authentication key since the authentication procedure is designed such that knowing a single or even several challenge/response pair(s) is not sufficient. If somebody has the SIM card then it would be possible to determine the cryptographic key for the storage medium; however, the present solution is intended as a privacy protection, not as a copy protection solution. Thus, it is assumed that once someone has the SIM card, he can read the content. However, the hacker would still need the user's PIN in order to access the SIM card.

Generally, the same cryptographic key is used for encrypting the whole content to be stored on a storage medium. However, it is also possible to use different cryptographic keys for different parts of the storage medium, e.g. by combining the identifier id with the start address of a storage medium fragment or a sub-identifier stored in a header and use this as an input to the authentication algorithm.

FIG. 2 shows a mobile phone network 1 according to the GSM standard to which a number of mobile phones 2, 3, 4 and a personal computer 5 can connect. Different embodiments of the invention shall be explained in the following.

The mobile phone 2 comprises a SIM card reader 21 for reading a SIM card 8. On the SIM card 8 an authentication key is stored which is a secret key shared with an authentication centre AuC of the GSM network 1 used for authentication of the mobile phone 2 when connecting to the network 1. The mobile phone 2 further comprises a drive D for reading and/or storing data on a removable storing medium 7, which can be a small form factor optical disc in the shown example. The disc 7 comprises a unique identifier which is readable by the drive D, e.g. a serial number stored in a particular area on the disc 7. Further, a transmission unit 22 is provided for transmitting the read identifier from the drive D to a SIM card reader 21 where a cryptographic key is generated by the authentication algorithm using the authentication key of the SIM card 8 and the identifier of the disc 7 as inputs. The generated cryptographic key is thereafter transmitted back to the drive D by a second transmission unit 23. The received cryptographic key can then be used by the drive D for encrypting data to be stored on the disc 7 or for decrypting data read from the disc 7. It shall be remarked that the cryptography can also be done in separate means outside the drive.

Instead of a removable storage medium 7 and an appropriate drive D it is also possible that the mobile phone comprises a drive D for reading non-removable storage media, such as shown for mobile phone 3 where the storage medium 9 is non-removable, such as a hard disc or a semiconductor memory. In this case, instead of using an identifier stored on the medium 9, the PIN of the SIM card 8 is preferably used as input to the authentication algorithm together with the authentication key stored thereon.

Since the present solution is not intended for copy protection, the user is able to freely copy its personal information. Thus, the user can copy the content from any device that contains the SIM, and the mobile phone can output the data to another device by either a wired or wireless connection. This includes transmitting the data through the wireless network itself.

Reading the storage medium in a device that is not intended to connect to the mobile network 1, e.g. a PC 5, and which therefore does not support the SIM 8, is more difficult. By connecting via an interface to the PC as shown for mobile phone 4 which can connect to the PC 5 using an interface 24 this problem can be avoided. However, if the PC 5 has a drive D that supports the discs 7 then the user will want to be able to read them and also record on them although the content stored thereon is protected. This can be solved by providing means in the PC 5 for allowing the user to connect, e.g. via the internet 6, to a fixed part of the mobile network 1. In this way the cryptographic key for accessing the disc 7 can be generated by the network 1, in particular the authentication centre AuC, by using the identifier of the disc 7 which is transmitted from the PC 5 via transmission unit 22 via the internet 6. Further, the authentication key available to the authentication centre AuC can be used. The generated cryptographic key is then transmitted back from the network via the internet 6 to a receiving unit 25 in the PC 5 so that the drive D can access the content stored on the disc 7.

Obviously in this case the network 1 must authenticate the user through the internet 6; however, many techniques exist to do this. Alternatively, a protocol can be defined to allow the mobile phone 4 to transfer the generated cryptographic key to the PC 5 so that the PC 5 can store the challenge/response pairs for the user's disc to allow accessing them in future without the mobile phone 4. Allowing the user to read the discs from a PC 5 in this way has the further advantage, that, if the SIM card is stolen or lost, the user can still read the content from its discs.

The present invention provides a high level of protection against unauthorized access of content stored in encrypted form on a storage medium. The used authentication procedure is very secure and can therefore be advantageously used for generating a cryptographic key for encryption of content.

The present invention is not limited to the particular embodiments shown in the figures. The invention can not only applied in a mobile phone network to which mobile phones are connected, but can be applied in other networks to which portable devices can be connected and which use a challenge-response authentication procedure similar or identical as described above.

1. A method of protecting content stored on a storage medium against unauthorised access, said storage medium being accessible by a drive (D) of a portable device which is connectable to a network (1), comprising the steps of:
transmitting an identifier (id) of said storage medium or the user to an authentication unit (Auc) within said portable device or within said network,
generating a cryptographic key (ck) using said identifier (id) and an authentication key (ak) by an authentication algorithm within said authentication unit (Auc),
transmitting said cryptographic key (ck) from said authentication unit (Auc) to said drive (D),
encrypting the content to be protected using said cryptographic key (ck), and
storing the encrypted content on said storage medium.

2. A method as claimed in claim 1, wherein said identifier (id) is stored on said storage medium in machine-readable form and is read before transmission to said authentication unit (Auc).

3. A method as claimed in claim 1, wherein said authentication unit is part of said portable device.

4. A method as claimed in claim 1, wherein said authentication key (ak) is stored within said authentication unit or on a removable authentication memory, in particular a SIM card, which is readable by said authentication unit.

5. A method as claimed in claim 1, wherein said authentication unit (Auc) is part of said network.

6. A method as claimed in claim 1, wherein said storage medium is a removable record carrier, such as an optical disk, a removable hard disk or a semiconductor memory card.

7. A method as claimed in claim 1, wherein said storage medium is a non-removable storage medium, such as a semiconductor memory or a non-removable hard disk.

8. A method as claimed in claim 1, wherein said portable device is a mobile phone, wherein said authentication unit is a SIM card reader, wherein said network is a mobile phone network and wherein said authentication algorithm corresponds to the algorithm used by said mobile phone network for authenticating mobile phones.

9. A method as claimed in claim 8, wherein said identifier (id) is the PIN of the user.

10. A method as claimed in claim 1, wherein said identifier (id) is transmitted from said portable device to said authentication unit (Auc) via the internet and a link from the internet to said network, in particular via a computer connected to the internet.

11. A device for protecting content stored on a storage medium against unauthorized access, said storage medium storing a machine-readable identifier (id), said device comprising:
means for connecting said device to a network,
a drive (D) for accessing said storage medium, in particular for reading content from and writing content to said storage medium,
a transmitter for transmitting an identifier (id) of said storage medium or the user to an authentication unit (Auc) within said device or within said network,
a receiver for receiving a cryptographic key (ck) generated within said authentication unit (Auc) by an authentication algorithm using said identifier (id) and an authentication key (ak) and for transmitting said cryptographic key (ck) to said drive (D), and
encryption means (D) for encrypting content to be protected using said cryptographic key (ck) for storage on said storage medium.

12. A method of accessing content stored in encrypted form on a storage medium, said storage medium being accessible by a drive (D) of a portable device which is connectable to a network, comprising the steps of:
transmitting an identifier (id) of said storage medium or the user to an authentication unit (Auc) within said portable device or within said network,
generating a cryptographic key (ck) using said identifier (id) and an authentication key (ak) by an authentication algorithm within said authentication unit (Auc),
transmitting said cryptographic key (ck) from said authentication unit (Auc) to said drive (D), and
decrypting the content to be accessed using said cryptographic key (ck).

13. A device for accessing content stored on a storage medium against unauthorized access comprising:
means for connecting said device to a network,
a drive (D) for accessing said storage medium, in particular for reading content from and writing content to said storage medium,
a transmitter for transmitting an identifier (id) of said storage medium or the user to an authentication unit (Auc) within said device or within said network,
a receiver for receiving a cryptographic key (ck) generated within said authentication unit (Auc) by an authentication algorithm using said identifier (id) and an authentication key (ck) and for transmitting said cryptographic key (ck) to said drive (D), and
decryption means (D) for decrypting content to be accessed using said cryptographic key (ck).

14. Device as claimed in claim 11, wherein said device is a mobile phone, wherein said authentication unit is a SIM card reader, wherein said network is a mobile phone network and wherein said authentication algorithm corresponds to the algorithm used by said mobile phone network for authenticating mobile phones.

15. Computer program comprising computer program code means for causing a computer to perform the steps of the method as claimed in claim 1 when said program is run on a computer.
